(19) United States
(12) Patent Application Publication
(10) Pub. No.: US 2008/0039136 A1
(43) Pub. Date: Feb. 14, 2008

(54) NETWORKING OF BLUETOOTH SYSTEM

(75) Inventor: Kyue Sup BYUN, Gyeonggi-do (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG ELECTRONICS INC.

(21) Appl. No.: 11/832,158

(22) Filed: Aug. 1, 2007

(30) Foreign Application Priority Data
Aug. 8, 2006 (KR) 10-2006-0074707

(51) Int. Cl. H04B 1/38

(52) U.S. Cl. 455/557

(57) ABSTRACT

The present invention relates to networking a Bluetooth system. The present invention includes receiving a Bluetooth signal from at least one Bluetooth device, searching for the at least one Bluetooth device, transmitting a pairable mode message to the at least one Bluetooth device for changing a current mode of the at least one Bluetooth device to a pairable mode, and requesting pairing with the at least one Bluetooth device.

### CROSS-REFERENCE TO RELATED APPLICATIONS

Pursuant to 35 U.S.C. §119(a), this application claims the benefit of earlier filing date and right of priority to Korean Application No. 10-2006-0074707, filed on Aug. 8, 2006, the contents of which are hereby incorporated by reference herein in their entirety.

### FIELD OF THE INVENTION

The present invention relates to networking a Bluetooth system.

### BACKGROUND OF THE INVENTION

Bluetooth® is a protocol for wirelessly connecting mobile devices within a short range at a low cost. Bluetooth allows connection between diverse digital devices without a physical cable and facilitates the transmission/reception of speech and data through a 2.45 MHz Industrial Scientific Medical (ISM) band radio frequency, which does not require a radio license. For example, Bluetooth wireless communication technology may be realized by a mobile phone or laptop computer communicating wirelessly with another electronic device. Almost all digital devices, such as Personal Digital Assistants (PDAs), desktop computers, facsimile (FAX) machines, keyboards, joysticks and the like, may be part of a Bluetooth system.

To set up a Bluetooth communication network between at least two devices in a Bluetooth system, an authentication process called pairing is performed. Pairing allows a host of a network to detect and access a target Bluetooth device.

FIG. 1 is a flowchart describing a networking method of a conventional Bluetooth system. Referring to FIG. 1, a networking method between a host 1, e.g., a computer or a mobile phone, and a Bluetooth device 5, e.g., a wired/wireless headset is illustrated. When the Bluetooth device 5 is turned on (P10), the Bluetooth device 5 creates and transmits a Bluetooth signal informing the activation of a Bluetooth function (P12).

Thereafter, a user sets a mode of the Bluetooth device 5 to a pairable mode in order to connect with the host 1 (P14). By doing so, the Bluetooth device 5 allows itself to be searched, detected and accessed by the host 1. The host 1 will then search for pairing targets (P16). When the host 1 detects the Bluetooth device 5, the host 1 will request the Bluetooth device 5 to perform pairing (P18). During pairing, the host 1 requests the user to input a passkey (P20).

The host 1 also requests the Bluetooth device 5 to be connected with to input a passkey (P22). In response, the Bluetooth device 5 transmits the passkey to the host 1 (P24). Herein, the host 1 may provide the Bluetooth device 5 with a window for inputting the passkey so that the user can input the passkey in the Bluetooth device 5.

The host 1 completes the pairing when the passkey inputted from the Bluetooth device 5 is the same as the passkey inputted by the user (P26). Accordingly, the host 1 has connected and built a network with the Bluetooth device 5 (P28). Thus, the host 1 may transmit and receive data to and from the Bluetooth device 5 and take advantage of the functions of the Bluetooth device 5.

Notably, the conventional networking process of the Bluetooth system is problematic because the process is performed manually. Specifically, the user is involved when setting the Bluetooth device 5 to the pairable mode and inputting the passkey to the host 1. Therefore, what is needed is a method of networking a Bluetooth system, such that the user is not inconvenienced during the networking process.

### SUMMARY OF THE INVENTION

The present invention relates exemplary Bluetooth systems and methods thereof capable of automatically networking between Bluetooth devices, thereby improving utility and convenience.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention is embodied in a method for networking a Bluetooth system, the method comprising receiving a Bluetooth signal from at least one Bluetooth device, searching for the at least one Bluetooth device, transmitting a pairable mode message to the at least one Bluetooth device for changing a current mode of the at least one Bluetooth device to a pairable mode, and requesting pairing with the at least one Bluetooth device.

In one aspect of the invention, the method further comprises determining a distance to the at least one Bluetooth device, and transmitting the pairable mode message to the at least one Bluetooth device if the distance to the at least one Bluetooth device is within a predetermined range.

In another aspect of the invention, the method further comprises detecting a power level of the received Bluetooth signal, and determining the distance to the at least one Bluetooth device according to the detected power level of the received Bluetooth signal.

In a further aspect of the invention, the pairable mode message is transmitted to the closest Bluetooth device. In another aspect of the invention, the method further comprises searching for a Bluetooth device in the pairable mode, and performing pairing with the Bluetooth device in the pairable mode. Additionally, a passkey may be provided to the Bluetooth device in the pairable mode.

In accordance with another embodiment of the present invention, a method for networking a Bluetooth system comprises transmitting a Bluetooth signal from a Bluetooth device to a host, receiving a pairable mode message from the host for changing a current mode of the Bluetooth device to a pairable mode, and receiving a request for pairing from the host.

Preferably, the host determines a distance to the Bluetooth device and transmits the pairable mode message if the distance to the Bluetooth device is within a predetermined range. Preferably, the host detects a power level of the Bluetooth signal and determines the distance to the Bluetooth device according to the detected power level of the Bluetooth signal.

In one aspect of the invention, the Bluetooth device is a Bluetooth device closest to the host. In another aspect of the invention, the method further comprises changing the current mode of the Bluetooth device to the pairable mode, and performing pairing with the host. Additionally, a passkey may be received from the host.

In accordance with another embodiment of the present invention, A Bluetooth system comprises a host and a Bluetooth device. Preferably the host comprises a host wireless interface for communicating radio signals, and a host controller for receiving a Bluetooth signal from the Bluetooth device through the host wireless interface, transmitting a pairable mode message to the Bluetooth device for changing a current mode of the Bluetooth device to a pairable mode, and requesting pairing with the Bluetooth device. Preferably, the Bluetooth device comprises a Bluetooth device wireless interface for communicating radio signals and receiving the pairable mode message from the host, and a Bluetooth device controller for transmitting the Bluetooth signal to the host through the Bluetooth wireless interface, changing the current mode of the Bluetooth device to the pairable mode upon receiving the pairable mode message through the Bluetooth device wireless interface, and performing pairing with the host.

Preferably, the host further comprises a range measurer for determining a distance to the Bluetooth device, wherein the host controller transmits the pairable mode message to the Bluetooth device if the distance to the Bluetooth device is within a predetermined range. Preferably, the host further comprises a power level measurer for detecting a power level of the received Bluetooth signal, wherein the distance to the Bluetooth device is determined according to the detected power level of the received Bluetooth signal.

In one aspect of the invention, the host controller transmits the pairable mode message to the closest Bluetooth device. In another aspect of the invention, the host controller searches for a Bluetooth device in the pairable mode through the host wireless interface and performs pairing with the Bluetooth device in the pairable mode. In a further aspect of the invention, the host controller provides a passkey to the Bluetooth device in the pairable mode, wherein the host comprises a passkey storage for storing the passkey.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 is a flowchart illustrating a conventional method for networking a Bluetooth system.

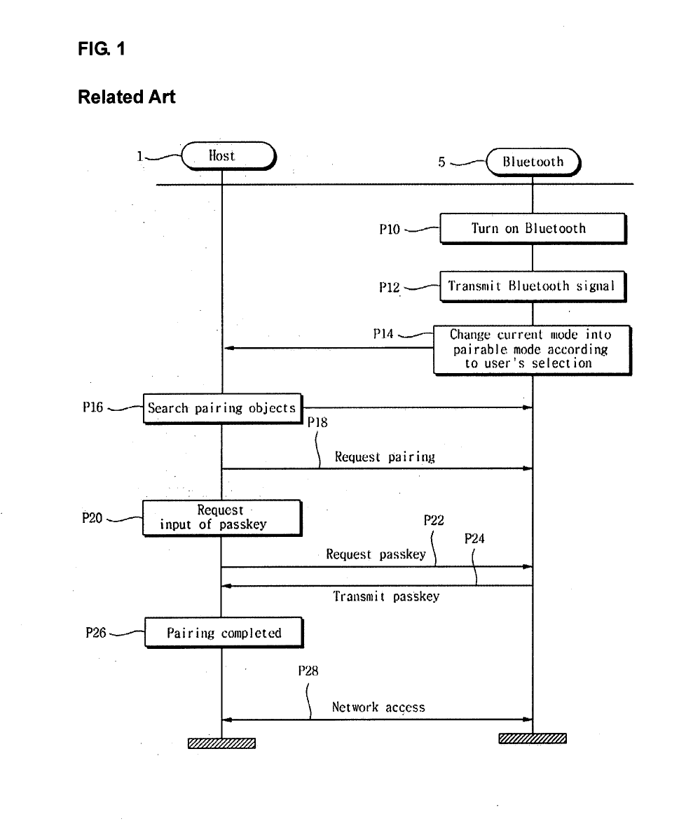

FIG. 2 illustrates a control structure of a Bluetooth system in accordance with one embodiment of the present invention.

FIG. 3 is a flowchart illustrating a method for networking a Bluetooth system in accordance with one embodiment of the present invention.

### DETAILED DESCRIPTION OF THE PREFERRED EMBODIMENTS

The present invention relates to networking a Bluetooth system. One or more implementations will be described in a more detailed manner with reference to the drawings.

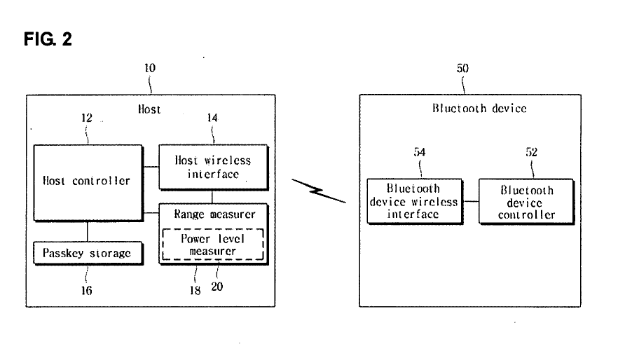

FIG. 2 is a block view illustrating a control structure of a Bluetooth system in accordance with one embodiment of the present invention. Referring to FIG. 2, the Bluetooth system comprises a host 10 supporting a Bluetooth function and a Bluetooth device 50 connected to the host 10. Preferably, the host 10 and the Bluetooth device 50 automatically perform pairing to build the Bluetooth system. The host 10 may be a computer or mobile phone supporting a Bluetooth function and the Bluetooth device 50 may be a wired/wireless headset that does not support a user input interface.

The host 10 comprises a host wireless interface 14, a range measurer 18, a passkey storage 16, and a host controller 12. The host wireless interface 14 transmits/receives radio signals to/from the Bluetooth device 50. The range measurer 18 senses Bluetooth signals transmitted from the Bluetooth device 50 through the host wireless interface 14. The passkey storage 16 stores a passkey for pairing. Preferably, the host controller 12 senses a distance to the Bluetooth device 50 through the range measurer 18, transmits a pairable mode message to a Bluetooth device 50 within a predetermined range, and performs pairing with the Bluetooth device 50 by providing the passkey stored in the passkey storage 16.

The host wireless interface 14 receives a radio signal transmitted from the Bluetooth device 50 and transmits the radio signal to the host controller 12. The host wireless interface 14 also transforms data provided by the host controller 12 into radio signals and transmits the radio signals to the Bluetooth device 50.

Preferably, the range measurer 18 comprises a power level measurer 20 for measuring the power level of a received signal, and determines a distance to the Bluetooth device 50 by measuring the power level of a received Bluetooth signal transmitted from the Bluetooth device 50. Preferably, the range measurer 18 obtains a range value according to the intensity of the Bluetooth signal and transmits the range value to the host controller 12.

The passkey storage 16 stores a passkey used to perform pairing with the Bluetooth device 50. The passkey is required to perform authentication when the host 10 is connected to the Bluetooth device 50. Here, it is possible for a user to directly input the passkey into the host 10 and the Bluetooth device 50. However, when the Bluetooth device 50 is not provided with a user input interface, the pairing is performed when the host 10 provides the passkey stored in the passkey storage 16 to the Bluetooth device 50.

In an automatic pairing mode, the host controller 12 automatically receives the Bluetooth signal transmitted from the Bluetooth device 50 through the host wireless interface 14. When the Bluetooth device 50 is detected, the host controller 12 transmits a pairable mode message for changing the mode of the Bluetooth device 50 to the pairable mode. In one aspect of the invention, the host 10 may attempt to pair with a plurality of Bluetooth devices 50 within a Bluetooth service coverage area by transmitting the pairable mode message to all Bluetooth devices 50 within the Bluetooth service coverage area.

The host controller 12 acquires range values of the Bluetooth devices 50 by processing the Bluetooth signal received through the host wireless interface 14 in the range measurer 18, and optionally transmits the pairable mode message according to the distance to the Bluetooth device 50. For example, the host controller 12 may transmit the pairable mode message to the Bluetooth device 50 upon the Bluetooth device 50 being placed close to the host 10. In this case, the user can build a network between the host 10 and a desired Bluetooth device 50 by placing the two devices close to each other.

Also, the host controller 12 may transmit the pairable mode message to Bluetooth devices 50 within a predetermined range according to the distance of each Bluetooth device 50 sensed in the range measurer 18. Herein, the predetermined range may be determined when the Bluetooth system is designed or determined directly by the user when the user wishes to connect Bluetooth devices 50 within the predetermined range to the host 10.

After transmitting the pairable mode message, the host controller 12 requests a connection to the Bluetooth device 50 and successfully pairs with the host 10 to thereby build a Bluetooth network.

Preferably, the Bluetooth device 50 comprises a Bluetooth device wireless interface 54 for transmitting and/or receiving radio signals to and/or from the host 10. The Bluetooth device 50 also comprises a Bluetooth device controller 52 for changing a mode of the Bluetooth device 50 to the pairable mode upon receiving the pairable mode message through the Bluetooth device wireless interface 54. Furthermore, the Bluetooth device controller 52 is able to receive a passkey upon pairing requested by the host 10, perform pairing, and allow access by the host 10.

The Bluetooth device controller 52 transmits a Bluetooth signal to inform the activation of a Bluetooth function when it is turned on, and checks whether a pairable mode message is received through the Bluetooth device wireless interface 54. When the pairable mode message is received, the Bluetooth device controller 52 transitions to a pairable mode allowing the host 10 to detect and recognize the Bluetooth device 50. The Bluetooth device controller 52 then performs pairing when requested by the host 10. In one aspect of the invention, mode changing of the Bluetooth device controller 52 is realized via software by the following mode changing program, for example:

<Example of pairable mode changing program>

while(Host-waiting)

{
/*Host receives connection message. */
If(automatic connection message of Host)
{
Mode of Bluetooth device is changed into pairable mode
break;
}
}

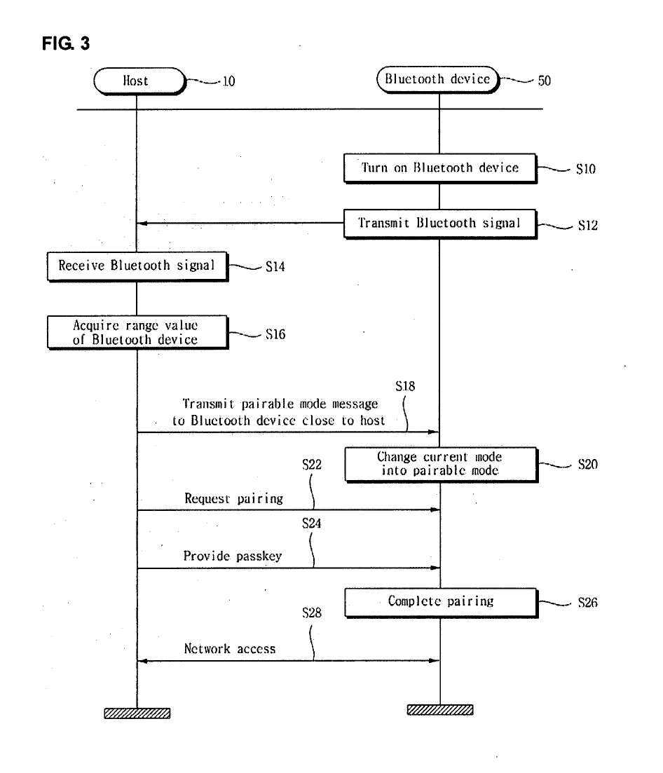

Networking processes of a Bluetooth system in accordance with the present invention will be described in detail with reference to FIG. 3. FIG. 3 is a flowchart describing a networking method of a Bluetooth system in accordance with one embodiment of the present invention.

Referring to FIG. 3, when the Bluetooth device 50 is turned on (S10), the Bluetooth device 50 transmits a Bluetooth signal informing the activation of a Bluetooth function (S12). The host 10 then receives the Bluetooth signal transmitted from the Bluetooth device 50 (Sl4) and senses a distance to the Bluetooth device 50 based on the power level of the received Bluetooth signal (S16).

The host 10 transmits a pairable mode message to the Bluetooth device 50 closest to the host 10 after sensing the distances of all Bluetooth devices 50 within the service coverage area (S18). Herein, the host 10 may sequentially transmit the pairable mode message to a plurality of Bluetooth devices 50 close to the host 10, or transmit the pairable mode message to all Bluetooth devices 50 existing within a predetermined range.

In response, the Bluetooth device 50 receives the pairable mode message and transitions to the pairable mode thereby allowing the host 10 to detect and recognize the Bluetooth device 50 (S20). After transmitting the pairable mode message, the host 10 requests the Bluetooth device 50 to perform pairing (S22). Preferably, if the Bluetooth device 50 does not support a user input interface, the host 10 provides a passkey stored in the passkey storage 16 to the Bluetooth device 50 (S24).

When pairing between the host 10 and the Bluetooth device 50 is completed using the passkey (S26), the host 10 requests a connection and builds a network with the Bluetooth device 50 (S28). Accordingly, the host 10 and the Bluetooth device 50 are able to communicate with each other.

As described above, the host 10 senses a range of each Bluetooth device 50 based on the signal level of the Bluetooth device 50, transmits a pairable mode message to the Bluetooth devices 50 close to the host 10 to change the mode of the Bluetooth devices 50 to the pairable mode, and subsequently performs pairing. When the Bluetooth device 50 does not support a user input interface, the host provides a passkey for pairing. Therefore, it is possible to automatically form a network between the host 10 and the Bluetooth device 50 without user selection and input.

The foregoing embodiments and advantages are merely exemplary and are not to be construed as limiting the present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalent but also equivalent structures.

What is claimed is:

1. A method for networking a Bluetooth system, the method comprising:
receiving a Bluetooth signal from at least one Bluetooth device;
searching for the at least one Bluetooth device;
transmitting a pairable mode message to the at least one Bluetooth device for changing a current mode of the at least one Bluetooth device to a pairable mode; and
requesting pairing with the at least one Bluetooth device.

2. The method of claim 1, further comprising:
determining a distance to the at least one Bluetooth device; and
transmitting the pairable mode message to the at least one Bluetooth device if the distance to the at least one Bluetooth device is within a predetermined range.

3. The method of claim 2, further comprising:
detecting a power level of the received Bluetooth signal; and
determining the distance to the at least one Bluetooth device according to the detected power level of the received Bluetooth signal.

4. The method of claim 2, wherein the pairable mode message is transmitted to the closest Bluetooth device.

5. The method of claim 1, further comprising:
searching for a Bluetooth device in the pairable mode; and
performing pairing with the Bluetooth device in the pairable mode.

6. The method of claim 5, further comprising providing a passkey to the Bluetooth device in the pairable mode.

7. A method for networking a Bluetooth system, the method comprising:
transmitting a Bluetooth signal from a Bluetooth device to a host;
receiving a pairable mode message from the host for changing a current mode of the Bluetooth device to a pairable mode; and
receiving a request for pairing from the host.

8. The method of claim 7, wherein the host determines a distance to the Bluetooth device and transmits the pairable mode message if the distance to the Bluetooth device is within a predetermined range.

9. The method of claim 8, wherein the host detects a power level of the Bluetooth signal and determines the distance to the Bluetooth device according to the detected power level of the Bluetooth signal.

10. The method of claim 8, wherein the Bluetooth device is a Bluetooth device closest to the host.

11. The method of claim 7, further comprising:
changing the current mode of the Bluetooth device to the pairable mode; and
performing pairing with the host.

12. The method of claim 11, further comprising receiving a passkey from the host.

13. A Bluetooth system, the system comprising:
a host; and
a Bluetooth device;
wherein the host comprises:
a host wireless interface for communicating radio signals; and
a host controller for receiving a Bluetooth signal from the Bluetooth device through the host wireless interface, transmitting a pairable mode message to the Bluetooth device for changing a current mode of the Bluetooth device to a pairable mode, and requesting pairing with the Bluetooth device;
wherein the Bluetooth device comprises:
a Bluetooth device wireless interface for communicating radio signals and receiving the pairable mode message from the host; and
a Bluetooth device controller for transmitting the Bluetooth signal to the host through the Bluetooth wireless interface, changing the current mode of the Bluetooth device to the pairable mode upon receiving the pairable mode message through the Bluetooth device wireless interface, and performing pairing with the host.

14. The Bluetooth system of claim 13, the host further comprising a range measurer for determining a distance to the Bluetooth device, wherein the host controller transmits the pairable mode message to the Bluetooth device if the distance to the Bluetooth device is within a predetermined range.

15. The Bluetooth system of claim 14, the host further comprising a power level measurer for detecting a power level of the received Bluetooth signal, wherein the distance to the Bluetooth device is determined according to the detected power level of the received Bluetooth signal.

16. The Bluetooth system of claim 14, wherein the host controller transmits the pairable mode message to the closest Bluetooth device.

17. The Bluetooth system of claim 13, wherein the host controller searches for a Bluetooth device in the pairable mode through the host wireless interface and performs pairing with the Bluetooth device in the pairable mode.

18. The Bluetooth device of claim 17, wherein the host controller provides a passkey to the Bluetooth device in the pairable mode.

19. The Bluetooth device of claim 18, the host further comprising a passkey storage for storing the passkey.
